(19) United States
(12) Patent Application Publication
(10) Pub. No.: US 2003/0191667 A1
(43) Pub. Date: Oct. 9, 2003

(54) System and user interface supporting use of rules for processing healthcare and other claim data

(76) Inventors: David Fitzgerald, West Grove, PA (US); Brian Lucas, Springfield, PA (US); Greg Long, Conshohocken, PA (US); David Hiebert Klassen, SR., Paoli, PA (US); John Hunter, North Wales, PA (US)

Correspondence Address: Siemens Corporation, Intellectual Property Department, 186 Wood Avenue South, Iselin, NJ, 08830, US

(21) Appl. No.: 10/308,648

(22) Filed: Dec. 3, 2002

Related U.S. Application Data
(60) Provisional application No. 60/371,027, filed on Apr. 9, 2002.
(60) Provisional application No. 60/372,764, filed on Apr. 12, 2002.

(51) Int. Cl. G06F 17/60

(52) U.S. Cl. 705/2

(57) ABSTRACT

A centralized rules repository maintains consistently expressed rules used to process patient claim data in supporting medical procedure eligibility verification, patient referrals, treatment authorization, data entry editing, electronic claim submission, claim status determination and electronic remittance processing. A system for managing rules used for processing claim data related to provision of healthcare to a patient includes an interface processor for acquiring data representing rules from a plurality of different sources. The system includes a rules repository for accumulating data representing acquired rules and a rules processor for initiating application of a selected rule derived from the repository to process claim data in response to a received message. A result processor processes a result being derived by the application of the selected rule to the claim data for output. The interface processor also transforms acquired rules to a common syntax suitable for storage in the rules repository.

This is a non-provisional application of provisional application serial No. 60/371,027 by D. Fitzgerald et al. filed Apr. 9, 2002 and of provisional application serial No. 60/372,764 by D. Fitzgerald et al. filed Apr. 12, 2002.

### FIELD OF THE INVENTION

This invention concerns a system and user interface for use in determining, applying and managing rules in processing claim data for payment for provision of services to patients by a healthcare provider, for example.

### BACKGROUND OF THE INVENTION

An important function performed by healthcare providers (such as hospitals, clinics or physicians) is the sending of claims to healthcare payer institutions to obtain reimbursement for provision of services to a patient. These claims may be in electronic or paper format. Paper claims typically go through a data entry process that converts them to an electronic format. The entered electronic claims are usually sorted, indexed and archived. Each claim is processed in a payer institution adjudication system. The payer adjudication system interprets the claim data and determines whether or not the claim is to be paid in full, partially paid or denied. This adjudication process may be fully automated, partially automated, or manual. The results of claim adjudication may include the issuance of a check and an explanation of benefits (EOB) to the insured and healthcare provider, or a request to send additional information. The process of reviewing claims is labor-intensive and error-prone.

In known systems, healthcare claim payer organizations provide healthcare providers with definitions of rules that are to be applied by payers in adjudicating claims submitted by healthcare providers. This means healthcare providers locally re-create and implement their own rules (that ideally mirror the payer rules) for use in creating claims and for establishing admission and treatment procedures that provide information compatible with rule requirements. However, a healthcare provider needs to interpret the rule definitions provided by a payer organization in order to implement rules locally. Further, a healthcare provider also needs to implement and apply claim processing rules derived from other sources such as from Regulatory institutions (such as a CCI—correct coding initiative rule) and from the healthcare provider itself (e.g., a rule to write-off small outstanding balances).

One known rules processing system operates as an adjunct to clinical systems to provide alerts and to help prevent medical errors. This rules processing system also provides suggestions to a user to reduce healthcare provider and payer organization costs such as by recommending a switch to cheaper alternative medications or to switch from an intravenous medication to an equivalent pill form, for example. Other rule processing systems approach rules from the claims perspective, developing claims editing applications to “scrub” claims prior to their electronic or manual submission. Another rule processing system provides a separate compliancy checking engine. In typical known rule processing systems, a healthcare provider establishes its own set of rules to address local and payer requirements using limited rule processing automation in ensuring patient claims are accurate before submission to a payer. This poses a set up, maintenance and compliance verification burden for an individual provider organization.

The known rule processing systems exhibit a number of problems that are compounded by the fragmentary, distributed and isolated nature of the rule databases employed by these systems. Specifically, problems arise in accurately trying to implement healthcare payer organization defined rules, in maintaining the rules, in processing rules employing variable format and syntax, in ensuring the latest rule versions are employed and in applying rules in a consistent manner. This results in claims that fail the edit process upon receipt by the payer and consequent disallowance by the payer. Disallowed claims cause delayed payment and negatively impact healthcare provider cash flow and patient satisfaction with the process. A system according to invention principles improves rule processing to enhance claim accuracy prior to claim submission to a healthcare payer institution.

### SUMMARY OF INVENTION

A centralized rules repository maintains consistently expressed rules used to process patient claim data in supporting medical procedure eligibility verification, patient referrals, treatment authorization, data entry editing, electronic claim submission, claim status determination and electronic remittance processing. A system for managing rules used for processing claim data related to provision of healthcare to a patient includes an interface processor for acquiring data representing rules from a plurality of different sources. The system includes a rules repository for accumulating data representing acquired rules and a rules processor for initiating application of a selected rule derived from the repository to process claim data in response to a received message. A result processor for processing a result derived by the application of the selected rule to the claim data for output.

### BRIEF DESCRIPTION OF THE DRAWING

FIG. 1 shows an overall claim data processing system employing rules processing, according to invention principles.

FIG. 2 shows a rules processing system used in the overall claim processing system of FIG. 1, according to invention principles

FIG. 3 shows a flowchart of a process employed in rules processing by the systems of FIGS. 1 and 2, according to invention principles.

FIG. 4 shows a user interface display image illustrating a patient claim billing record for multiple patient encounters with a healthcare provider concerning treatment of an injury, according to invention principles.

FIG. 5 shows a user interface display image illustrating a rule profile for a hospital 500 indicating rules and tests selected to be applied in processing patient claim data, according to invention principles.

FIG. 6 shows a user interface display image illustrating results of applying exemplary rules in processing claim data and identifying claim rejection reasons by description and rejection code, according to invention principles.

FIG. 7 shows a flowchart of a process employed in deriving and amending rules in response to claim adjudication results from a payer organization, according to invention principles.

FIG. 8 shows a user interface display image illustrating an exemplary rule code language common syntax format for issuing an alert in response to particular occurrences, according to invention principles.

FIG. 9 shows a user interface display image illustrating another exemplary rule code language common syntax format used in processing claim data, according to invention principles.

FIG. 10 shows a user interface display image illustrating claim processing results and identifying claim rejection reasons by description and rejection code, according to invention principles.

FIGS. 11-17 show data records including data elements incorporated in a central data repository used in claim processing, according to invention principles.

### DETAILED DESCRIPTION OF INVENTION

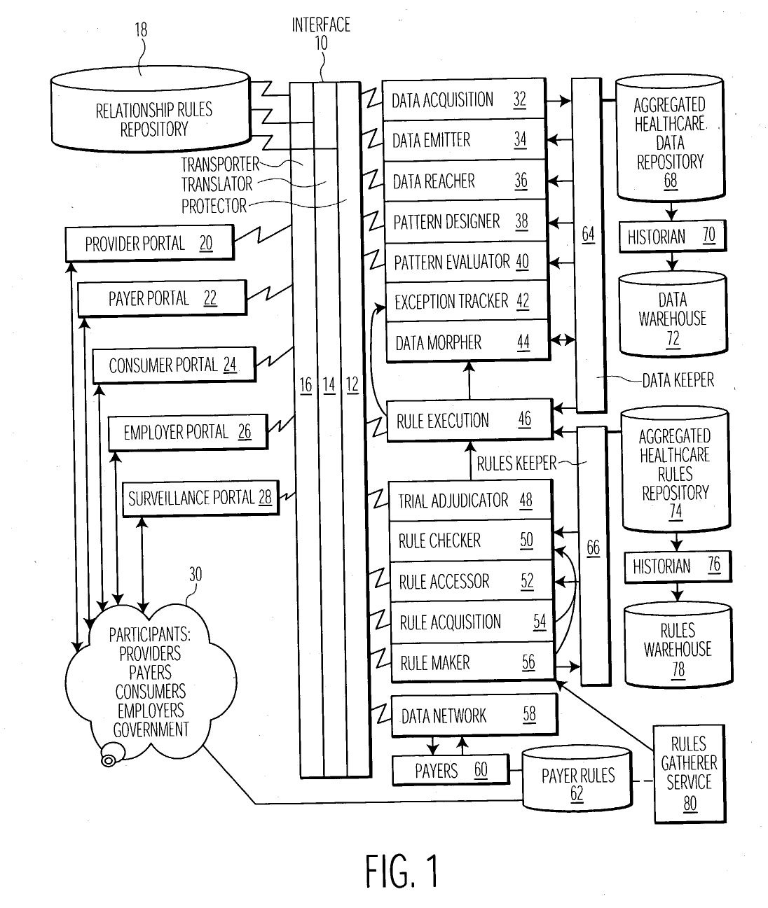

FIG. 1 shows an overall claim processing system employing trial adjudication to improve claim accuracy prior to claim submission to a healthcare payer institution or other entity. In the FIG. 1 system, continuously updated centralized common rules in repository 74 are employed to ensure that individual healthcare providers, as well as individual healthcare payer institutions are working with the most up-to-date version of the rules. Use of centralized rules ensures that a healthcare provider is able to comply with the latest provisions of the rules. A rule as used herein comprises a procedure (including an executable procedure or a procedure implemented with manual intervention) for determining that healthcare claim elements comply with predetermined requirements including, health plan reimbursement conditions, health plan format requirements, a reimbursement formula, reimbursement constraints and a reimbursement computation procedure. A rule also may comprise a prescribed guide, a precept, or a model for how to present, conduct or regulate an action by using a form and data or the relations between form and data. In other embodiments, the rules repositories described herein may also be arranged as a single repository or multiple repositories in a different arrangement. Further, an exception as used herein encompasses the identification of an issue and mechanism to process that issue and claim elements as used herein may comprise a portion of a claim, a complete claim, individual records of a claim and record data associated with an individual patient encounter with a healthcare service provider. In addition a window as used herein comprises an image area used for display of desired text or graphics or other content to a user and is not limited to a Microsoft or any other particular operating environment.

Centralized rules repository 74 enables consistency in consolidation and communication of rule sets across participants in the healthcare industry. Rules repository 74 contains up to date current rules for checking by unit 50 and execution by unit 46. The rules are expressed in a standard syntax and process standard claim data identifiers and value sets to ensure compatibility with multiple application platforms and health enterprises. The system of FIG. 1 supports collecting and combining rules across multiple healthcare entities for processing healthcare patient encounter information and associated claim data to ensure claim accuracy. An encounter as used herein comprises a patient encounter with a healthcare enterprise involving patient and healthcare enterprise interaction that has a financial or transaction consequence and may include for example a patient visit, phone call, inpatient stay or outpatient treatment etc. Centralized rules repository 74 ensures that system participants stay compliant with rapidly changing rules and regulations. Further, the use of clinical event-driven application of rules when needed (rather than sequential processing after the fact) gives confidence that requested actions occur without unexpected, late or retroactive claim denials occurring. Rules change frequently and especially in response to the introduction of new technology, procedures, and medications. Repository 74 advantageously maintains effective validity dates and decommissioning dates for rules as well as a record of obsolete or out-of date rules. Further, the selection and operation of rules in processing claim data is affected by particular dates associated with a patient healthcare encounter such as an admission date, birth date, discharge date, and treatment date.

The FIG. 1 system invokes rules to automate the pre-registration, eligibility, registration authorization, claim generation, trial adjudication, claim submission, payment remittance, and post-remittance processes of a health care claim data processing cycle to provide seamless, accurate and prompt claim processing. The system facilitates coordination of employer and payer activities and ensures that pre-visit enrollee data is accurate. Thereby, if a patient uses a consumer portal (24) to schedule a visit or if a healthcare facility collects insurance information from a patient, medical necessity, referral and eligibility verification processing is automatically initiated. A claim is evaluated for accuracy and edited by a rule execution function 46 and adjudication unit 48, using the applicable rules in rules repository 74, both before the claim is completed (i.e. as individual claim elements for individual healthcare encounters post to the claim, for example) and again before the completed claim is submitted for payment. A variety of portals 20-28 in the FIG. 1 system are controlled and administered by interface 10 to provide claim data access to patients, payers, providers, employers and government agencies. The system facilitates healthcare provider compliance with governmental and payer rules through use of automated, rules-based editing and review systems.

The FIG. 1 system automatically employs rules from repository 74 to edit claim data to ensure claims are error free. The system also advantageously performs claim trial adjudication (pre-processing) using the rules to validate that edited collated claim data is in condition for submission for actual adjudication by a payer institution to initiate generation of payment. A failure in trial adjudication automatically initiates deficiency correction or manual intervention via scheduling of a worklist task to be performed by expert personnel. Upon successful trial adjudication, the claim data is automatically re-queued for electronic submission to the payer. Payment advice is processed electronically without manual intervention and automatically posted to an appropriate account.

The FIG. 1 system comprises functions implemented in software applications and executable procedures for processing claim data. These functions may also be implemented in hardware or a combination of both hardware and software resident in one or more computer systems and servers and involving one or more communication networks for internal and external communication. The system processes claim data related to provision of healthcare to a patient by collating data related to a claim for a particular patient for submission to a payer. The collated claim data is submitted for pre-processing using rules to validate the collated claim data is in condition for processing to initiate generation of payment. Upon successful validation the validated claim data is submitted to a payer. The claim data is collated by data acquisition unit 32 via interface 10 for storage in data repository 68. Repository 68 contains financial and clinical data related to healthcare encounters that are currently ongoing. Data acquisition unit 32 is able to receive both solicited and unsolicited data from multiple different sources and to request data from these sources via interface 10. The different sources include external users (participants) subscribing to and using the FIG. 1 system and may include for example, healthcare providers, healthcare payer institutions (e.g. insurance companies, Health Maintenance Organizations—HMOs etc.), consumers, employers, and government agencies.

Data keeper unit 64 acts as a gateway and data management system governing data storage and retrieval for healthcare data repository 68 and processing requests to use repository 68 to store, modify, and retrieve data. Data keeper unit 64 also tracks data changes in repository 68 by recording time, date and nature of changes made as well as the source and identity of the author of the changes to maintain a data update audit trial. Historian unit 70 is used in archiving and maintaining older data value versions and is specifically used in archiving data records associated with patient encounters following completion of financial transactions (i.e. encounters for which no related financial transactions are outstanding) and processing for these encounters. Records of such encounters are maintained by data keeper unit 64 in repository 68. Historian unit 70 stores archived data in archive (data warehouse) database 72.

The collated claim data is submitted for pre-processing by trial adjudicator 48 using rules to validate the collated claim data is in condition for processing to initiate generation of payment. Trial adjudicator 48 initiates execution of a sub-set of rules executed by rule execution unit 46. Unit 46 detects the occurrence of an event triggering application of associated rules and executes the rules associated with that event. An event may include receipt of data to add to the repository 68, a request to execute a specified list of rules, and an event triggered by the activities of a function within the FIG. 1 system. A rule executed by unit 46 may itself generate a triggering event and initiate execution of other rules. An individual rule may contain a test resulting in assignment of a result status of “True” or “False” upon execution of a rule. An individual rule may also contain lists of actions to be performed upon a true result and alternate actions to perform upon a false result, for example. The list of actions may include, creation of worklists of tasks for automatic or manual performance, creation of logs and audit reports and accounting reports, creation of error reports, generation of claims, posting of remittances, modification of data, and other actions. Data Morpher unit 44 comprises a sub-category of actions that rules invoke to modify data in repository 68 in response to command. Unit 46 also processes and executes rules stored in the Relationship Rules Repository 118 that contains rules required and used by the Protector 12, Translator 14, and Transporter 16 during communication involving interface 10.

The rules executed by trial adjudication unit 48 determine expected adjudication results when a specified set of claim data is submitted to a specified payer. Unit 48 uses rules retrieved from repository 74 (or from rule accessor 52) via rule keeper interface 66 to predict the result of submitting a specified set of claim data to a specified payer. For this purpose the rules used by unit 48 replicate the rules used by the selected specific payer. Unit 48 identifies conditions that would lead to denial of payment and enables such conditions to be fixed (automatically or with manual intervention) before a claim is submitted to a designated payer. This procedure advantageously facilitates the creation of error-free claims using rules derived from repository 74 or using remotely accessed rules. Rules including regulatory guidelines and directives are continuously acquired for storage in repository 74 and are continuously updated and maintained in this repository via rules keeper unit 66. Rules repository 74 incorporates healthcare data rules that employ a universal catalog of code-sets listing physician identifiers and patient relationships and govern how data is to appear in an electronic form, image or other presentation. These rules include format rules that determine data formatting and use a universal catalog of implementation guides including form UB92 requirements, electronic version 6 or ANSI 837p version 4010 requirements including selectable date formats (e.g., mm-dd-yyyy or yyyy-mm-dd, etc.). Repository 74 also includes healthcare compliancy rules that are mandated by regulators and employ a universal catalog of code-sets like diagnosis codes, correct coding initiative requirements as well as Ambulatory Patient Groups (APGs) and Diagnosis Related Groups (DRGs) patient classification systems. Repository 74 also includes lists identifying rule names, grouping sets of rules together and specifying rule sets to be executed sequentially and also includes business or other rules facilitating business operations. System connectivity rules are also retained in repository 74 and also in relationship rules repository 18 (in support of communication via interface 10). Such connectivity rules support e-commerce communication (e.g., use FTP@2400 k baud to a certain node name) or determine a communication mode (e.g., prompt a user to e-mail to ask questions or probe a response). Other rules detect inconsistency between data fields such as data fields retaining a telephone number, zip code, address or other geographical identifier of the collated claim data.

Rules archiving unit 76 in conjunction with unit 66, dates and time stamps rules to be archived and stores obsolete, expired or older version rules in archive (rules warehouse) database 78. Archived rules are accessible and usable to determine an outcome based on submission of particular claim data for adjudication using rules in force at a date in the past, for example. Repository 74 contains adjudication rules acquired from payer institution participants and rules that are established from previous transactions with payers. Repository 74 also contains rules developed by the system and by authorized participants that add automated processes to the system. Pattern creator unit 38 creates specialized rules that define surveillance research processes and rule maker unit 56 is used to create general purpose rules.

Unit 48 uses rules in repository 74 derived from external rule sources (such as rules 62 owned by a payer institution 60) by rule accessor 52 via interface 10 and data network 58. Network 58 may comprise a conventional network such a LAN (local area network), WAN (wide area network) or the Internet or alternatively may comprise a network service such as a clearinghouse or other service used by a healthcare payer or a healthcare provider to facilitate data and rule (e.g., payer rules 62) acquisition for claim adjudication. Payer rules 62 are rules promulgated by a payer 60 that are not accessible through the automated process managed by Rule acquisition unit 54. Rather rules 62 are manually determined through manual acquisition processes and are parsed and analyzed by Rule acquisition unit 54 by using a user interface provided by rule maker unit 56. The Rule Maker 56 user interface supports manual creation, review and update of rules including those acquired via unit 54. Unit 56 also prompts a user with lists of available tests and actions and guides the user through the process of constructing and editing rules prior to storing the edited rules in Rules Repository 74.

Rule acquisition unit 54 accumulates rule data based on adjudication outcomes of prior claim submissions to payer institutions and through documentation and other information provided by payers that do not provide access to their proprietary programmed rule sets to external users. Unit 54 retrieves payer generated information bulletins from payer websites and other sources and analyzes this material to identify information representing new rules for incorporation in repository 74 and to identify rules that have expired. Further, individual payer institutions may use Payer Portal 22 to communicate rule information via interface 10 to acquisition unit 54 which incorporates them using rule keeper unit 66 in repository 74. Unit 54 also receives new rules following user manual data entry and processing via a user interface provided by rule maker 56 based on information acquired from payers by rules gatherer service 80. Payers forward updated rule information to service 80 in advance of implementing a new rule or rule version, for example. Service 80 supports user creation of implementable definitions of these new or updated rules using Rule Maker user interface 56 for incorporation in rules repository 74. Service 80 also monitors claim rejection issues and rates of adjudication success and failure and supports adjustment or creation of rules to resolve identified issues. Rule Checker unit 50 monitors rules in repository 74 and identifies and indicates to a user those rules that are incomplete or contain incorrect syntax. Unit 50 also reports combinations of rules that are mutually inconsistent. Further, in response to identification of a predetermined exception condition during claim data processing by rule execution unit 46 and trial adjudication unit 48, exception tracker function 42 employs a sub-set of rules managing the processing and reporting of an identified exception condition. Exception tracker function 42 may be invoked by rule execution unit 46 in response to execution of a particular rule or upon a particular result of executing a rule. Upon determination of an exception condition, function 42 may schedule manual intervention, via a user interface or a worklist or by communicating a report or message to a recipient, for example.

Trial adjudicator 48 uses rule accessor 52 to submit claim data for trial adjudication by remotely located rules. These remotely located rules may be maintained (and owned) by a different entity (such as a payer institution) to the owner of the FIG. 1 system. A payer who owns such rules establishes a procedure for receiving claim data for trial adjudication and responds with a report indicating how the submitted claim data would be adjudicated using the payer owned rules.

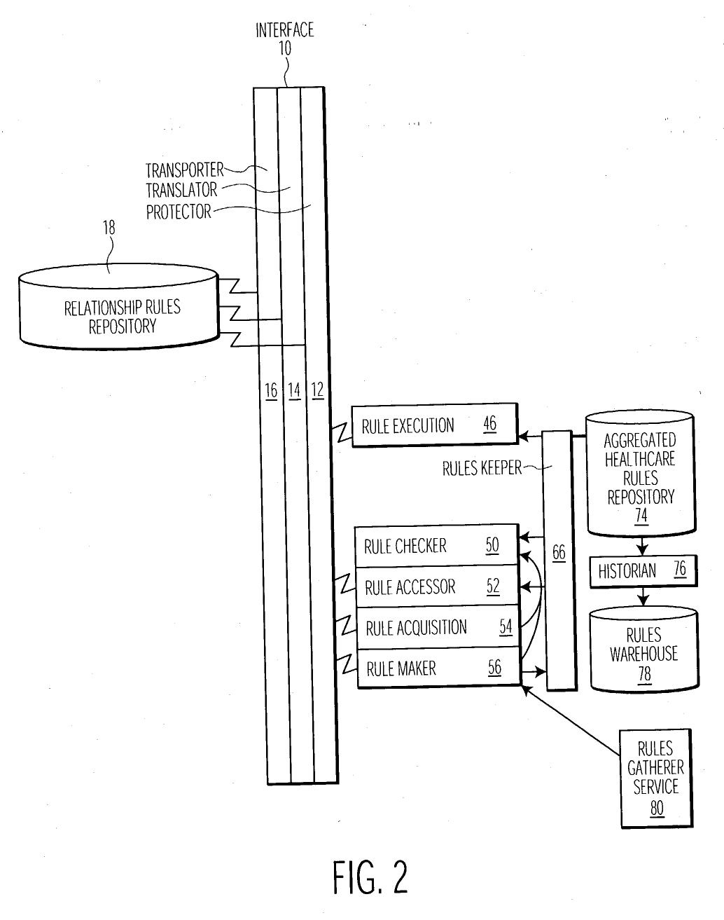

FIG. 2 shows a rules processing system including server based rule functions (specifically rule functions 18, 46, 50, 52, 54, 56) used in the overall claim processing system of FIG. 1. As previously described, unit 46 executes rules derived from repository 74 via interface 66 in processing patient claim data. The rules in repository 74 are derived from external rule sources (such as rules 62 owned by a payer institution 60—FIG. 1) by rule accessor 52 via interface 10 and data network 58 (FIG. 1). Rule acquisition unit 54 parses and analyzes acquired rules (derived by rules gatherer service 80 and manual entry and other means) using a user interface provided by rule maker unit 56 in the manner previously described in connection with FIG. 1. Relationship Rules Repository 18 contains rules required and used by the Protector 12, Translator 14, and Transporter 16 during communication involving interface 10 and other rules used in establishing communication.

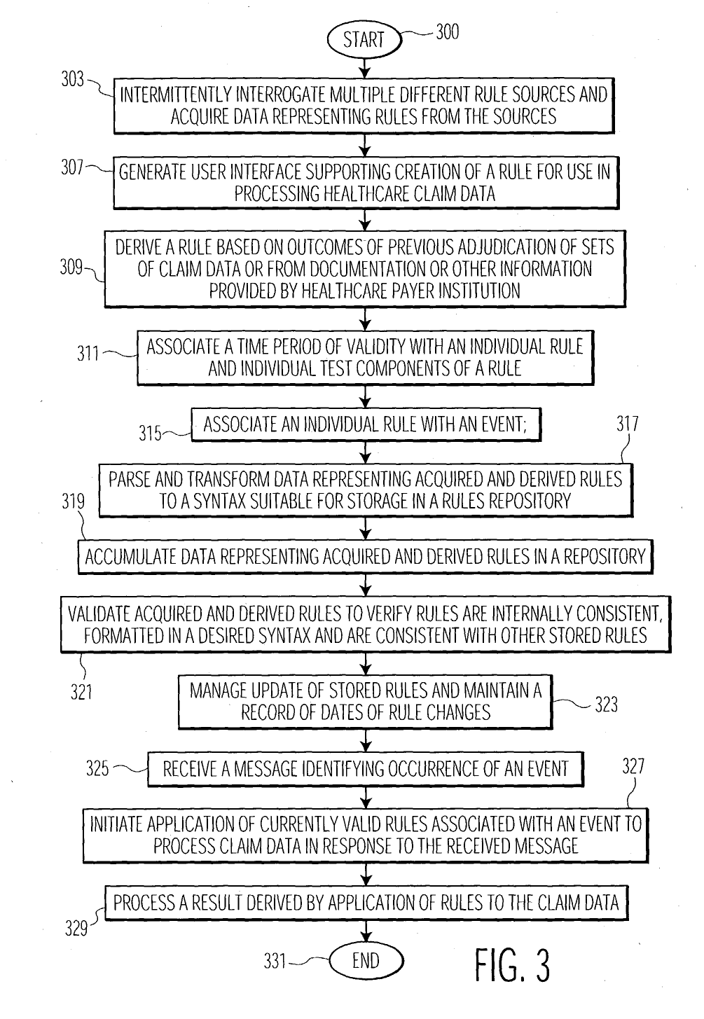

FIG. 3 shows a flowchart of a process employed by the system of FIG. 1 in claim processing. In step 303, after the start at step 300, units 52 and 54 (FIG. 1) intermittently interrogate multiple different sources to acquire, new rules and updates of existing rule held in repository 74. The different sources include, payer organizations, messages provided by payer organizations, payer organization websites, regulatory guidelines and a source of rules created in response to previously identified claim data deficiencies. In step 307 unit 56 initiates generation of user interface display images supporting creation of a rule for use in processing healthcare claim data. Specifically, unit 56 initiates generation of displayed image windows including prompt elements permitting user selection of a rule or a test to be performed on claim data as part of a created rule. The test is selected from available predetermined tests. Another image element permits user identification of a source of claim data to be processed by a created rule and a further image element supports user initiation of validation of a created rule to verify the created rule complies with predetermined criteria. An additional image element supports generation of text hints for display to a user to guide a user in creating a rule. Unit 56 also initiates generation of a window including a prompt element permitting user selection of a resultant action to be performed in response to application of a created rule to claim data and a window for displaying the created rule.

In step 309, rule maker 56 derives a rule based on information concerning outcomes of previous adjudication of other sets of claim data. This outcome information is acquired by service 80 from payers or from monitoring claim rejection issues and rates of adjudication success and failure and supports adjustment or creation of rules to resolve identified issues. An individual rule may contain one or more tests to identify a true condition and initiate an associated first set of actions or a false condition and initiate an associated second set of actions. A rule test condition may be simple or complex involving a combination of tests linked with logical operators (e.g., “and,” “or,” “not”). Individual linked tests results are logically combined to provide an overall test true or false result. Unit 66 in step 311 assigns a time period of validity to both a rule and individual test components incorporated by the individual rule. Rules and tests are stored together with associated time and date stamp indicators of duration of validity in repository 74. In step 315, rules repository 74 also associates a particular rule with an event including, for example, (a) the generation of a record for incorporation in claim data for a patient, (b) the detection of a record addition to claim data for a patient, (c) the detection of a record addition to a patient billing record, (d) the detection of a change in a patient billing record and (e) the detection of a change in claim data for a patient.

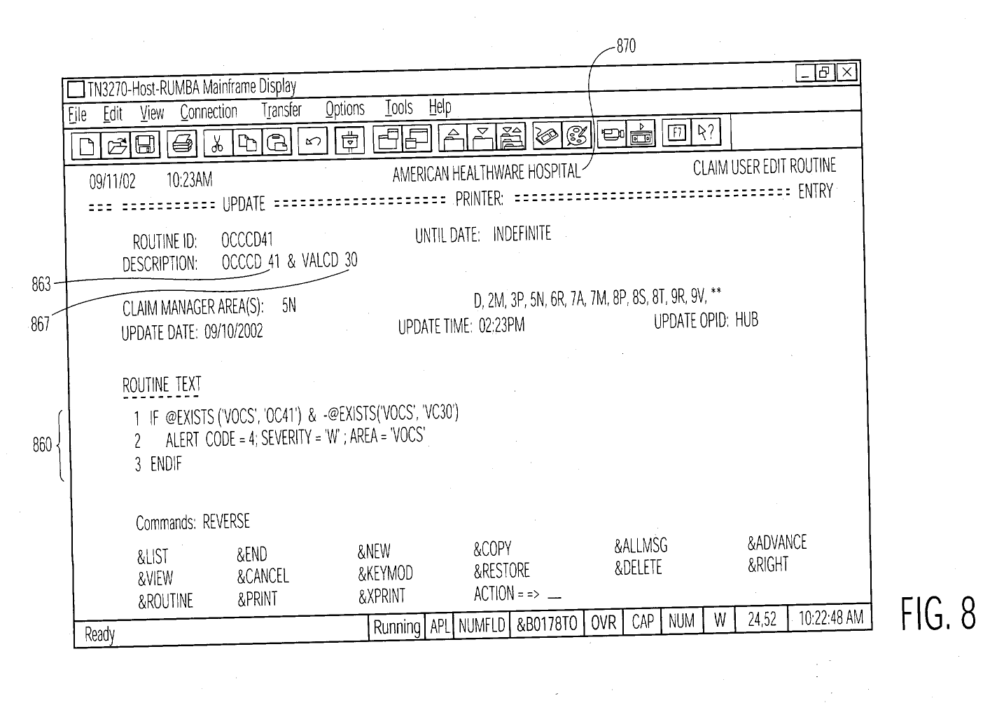

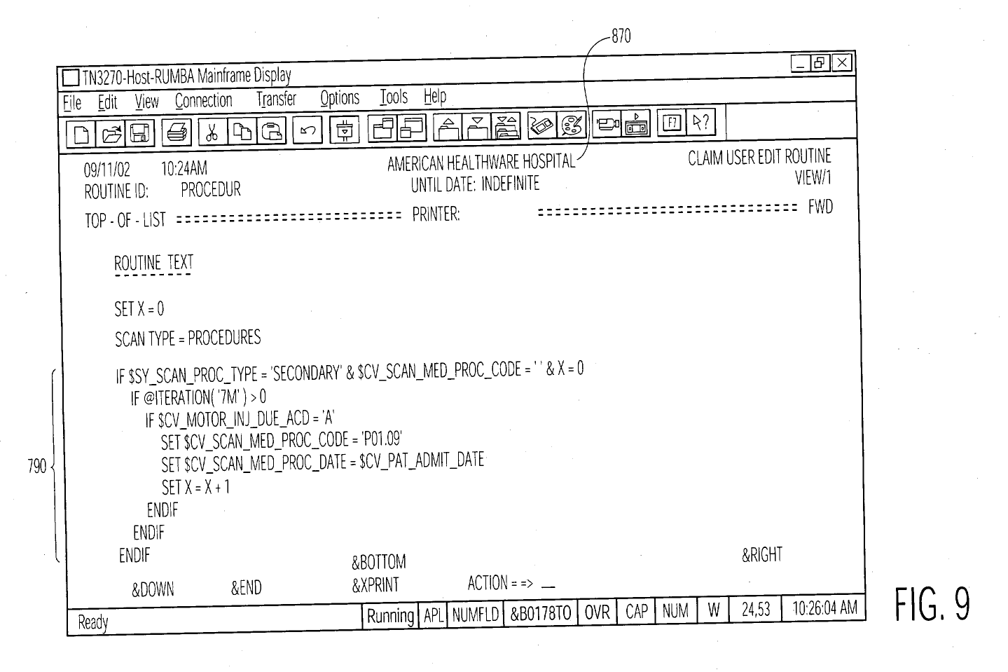

Unit 56, in step 317, parses and transforms data representing acquired and derived rules to a syntax suitable for storage in repository 74. For this purpose, unit 56 parses data representing acquired rules in converting the acquired rules to a common syntax using predetermined identifiers and predetermined value sets. FIG. 8 shows a user interface display image illustrating an exemplary rule code language common syntax format for a rule used to process claim data of a hospital (870) to issue an alert in response to particular occurrences. Specifically, a rule 860 employs a common If-EndIf statement language syntax. This is used identify occurrences of both Occurrence code 41 and Value Code 30 (items 863 and 867 respectively) in claim representative data and to initiate generation of a warning message to a user in response to such an identification. Similarly, FIG. 9 shows a user interface display image illustrating another exemplary rule code language common syntax format used in processing claim data. Specifically, a rule 790 employs a multi-level common nested If-EndIf statement language syntax. This is used to identify whether there is a secondary procedure code in claim representative data that indicates a claim entry is associated with an injury due to a vehicular accident. If no such procedure code is present the rule adds procedure code P01.09 as well as a procedure date equal to the admission date. The “x” counter (i.e., x=0 statement of line 1 of rule 790) ensures that this routine is run once.

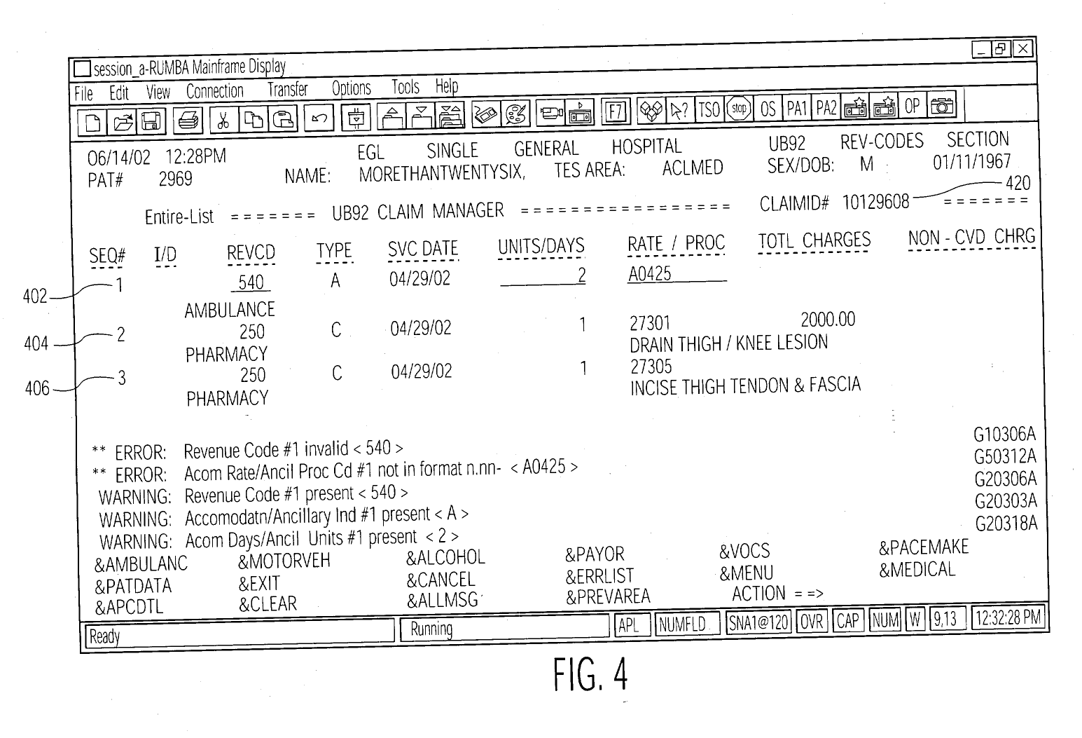

Units 52 and 54 in step 319 accumulate data representing acquired and derived rules in repository 74 via rule interface unit 66. Rule checker 50, in step 321, validates acquired and derived rules to verify the rules are internally consistent, formatted in a desired syntax and are not inconsistent with other rules in repository 74. In step 323 unit 56 manages update of rules repository 74 and maintains a record of a first date of validity of a rule, a last date of validity of a rule and a date identifying when a rule is changed. In response to receiving a message identifying an event in step 325, unit 46 in step 327 initiates application of a particular rule associated with the event (see step 315) to process collated claim data derived from data repository 68 and related to a claim of a particular patient. However, unit 46 examines rule validity periods and does not execute a rule or test component at a time and date falling outside of a period of validity. FIG. 4 shows a user interface display image illustrating a claim billing record for a particular patient (the patient is identified by item 420). The billing record includes collated claim data for multiple patient encounters 402, 404 and 406 with a healthcare provider concerning treatment of an injury.

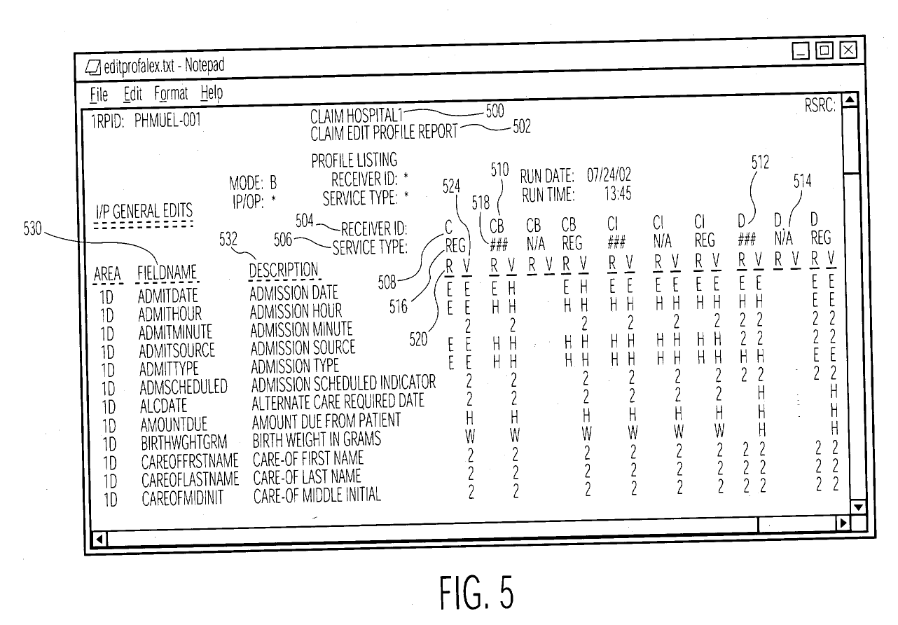

FIG. 5 shows a user interface display image illustrating a rule profile 502 for a hospital 500 indicating rules and tests selected to be applied in processing patient claim data. The rules and tests are specified to be applied to data in individual claim element fields identified in column 530 and described in column 532. Initially, claim data is parsed to identify whether a claim contains particular characteristics (e.g., whether the claim is covered under Medicare or Medicaid plans). The identified characteristics are interpreted to derive values for two data elements, Receiver ID 504 and Service Type 506. For example, pre-defined categories of claims include, Medicare part A (Receiver ID=C, e.g. item 508), Medicare part B (Receiver ID=CB, e.g. item 510) or Medicaid (Receiver ID=D, e.g. item 512). Service Types include, “REG” (item 516) to indicate a predetermined standard set of rules and tests are to be applied, “###” (item 518) indicating Service Type is not specified and that a predetermined default set of rules and tests are to be applied, and “N/A” (item 514) to indicate reports that are not associated with claims needing processing. Other Service Types 506 and Receiver ID 504 elements may be used and those described are merely exemplary. Data elements 504 and 506 are used to determine which rules and tests to apply to individual claim element fields identified in column 530 for a particular category (504) and service type (506) of claim.

The rules and tests that are applicable to claim element fields 530 for a particular category 504 and service type 506 of claim, include a requirement test identified under column headers R (e.g. item 520) and a validation test identified under column headers V (item 524). An entry in column R adjacent to a particular claim element field 530 identifies an action to be taken if the particular claim element field 530 does not contain a value. An entry in column V adjacent to a particular claim element field 530 identifies an action to be taken if the particular claim element field 530 value does not conform to predetermined test criteria. Exemplary action identifiers listed in column R include, “E” indicating an error is to be declared if no value is present, “2” indicating the field is to be cleared if it contains a value, “H” indicating the claim is to be Held if no value is present and “W” indicating a warning message to a user is to be generated if no value is present. Similarly, exemplary action identifiers listed in column V include, “E” indicating an error is to be declared if a detected value fails validation tests or rules, “2” indicating the field is to be cleared if it contains a value, “H” indicating the claim is to be Held if a detected value fails validation tests or rules, and “W” indicating a warning message to a user is to be generated if a detected value fails validation tests or rules. These actions are exemplary only and others are also employed. Therefore, for example, if an admission date field 530 contains no value in a Medicare (part A) claim with a REG service type, an Error is generated. Further, if an admission date field does contain a value in a Medicare (part A) claim with a REG service type, and the detected value fails validation tests and rules, an error is generated.

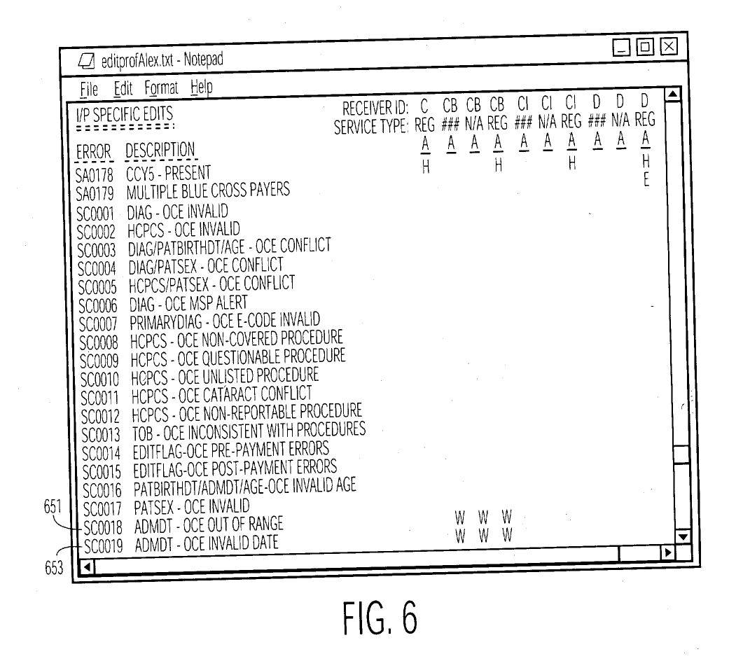

FIG. 6 shows a user interface display image illustrating results of applying rules in processing claim data and identifying claim rejection reasons by description and rejection code. Specifically, errors 651 and 653, for example, (error codes sc00018 and sc00019) indicate a claim data admission date value is out of range or is invalid, respectively. These errors prompt warning messages for Medicare part B category claims with Service Types “REG”, “###” and “N/A” as previously discussed.

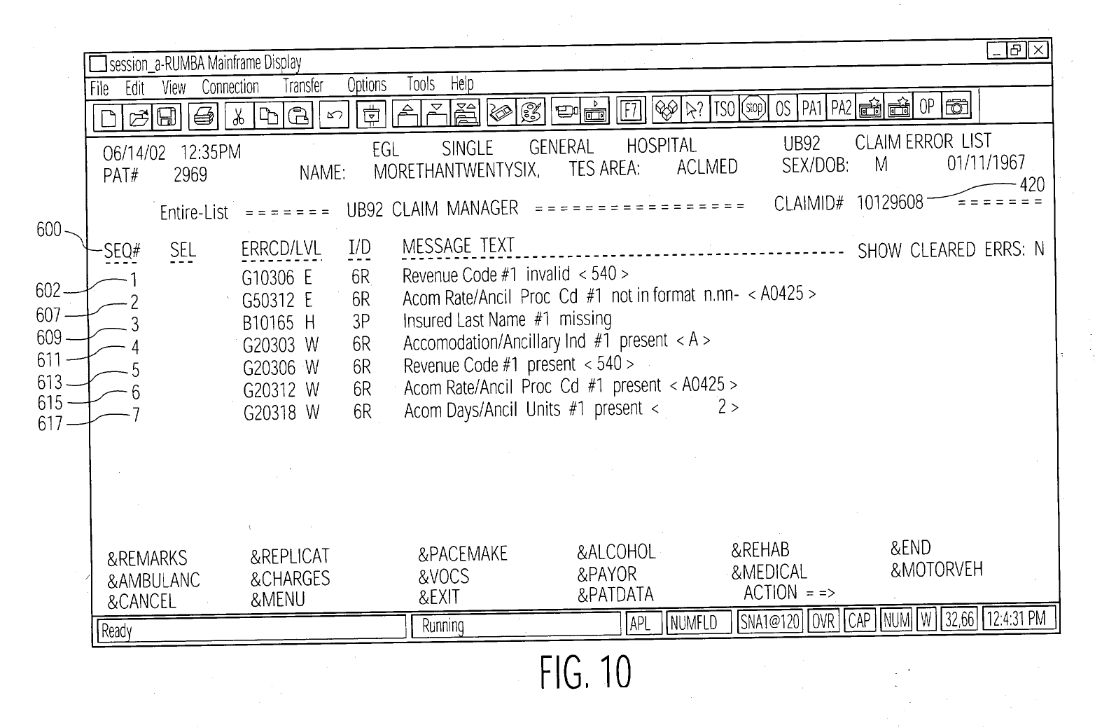

FIG. 10 shows a user interface display image illustrating claim processing results of applying validation rules in step 327 and identifying claim rejection reasons by description and rejection code. Specifically, line 600 indicates error list heading labels defining columns comprising, an error code sequence, an error code identifier and level, an error code sub-identifier, error description text and cleared errors identifying errors that have been corrected (none in this example). Lines 602-617 list results of applying validation rules to claim data for a patient. The results list identifies 7 claim rejection reasons comprising, an invalid revenue code (602), a data format deficiency (607), a missing name portion (609), an accommodation data warning (611), a revenue code related warning (613), a procedure code related warning (615) and accommodation or ancillary data warning (617).

Continuing with step 329 of FIG. 3, unit 46 processes a result derived by application of selected rules to claim data to provide an output. Unit 46, in response to a result derived by application of a rule, may schedule a task to be performed by a healthcare worker, initiate creation of an error report, initiate creation of a record of a result of applying rules to edit claim data, or initiate creation of an accounting report. Unit 46 may also initiate, generation of a claim, sending of a remittance, scheduling of review of claim data to be performed by a healthcare worker or generation of an alert message to a user to indicate a deficiency in claim data likely to result in claim denial. The process of FIG. 3 ends at step 331.

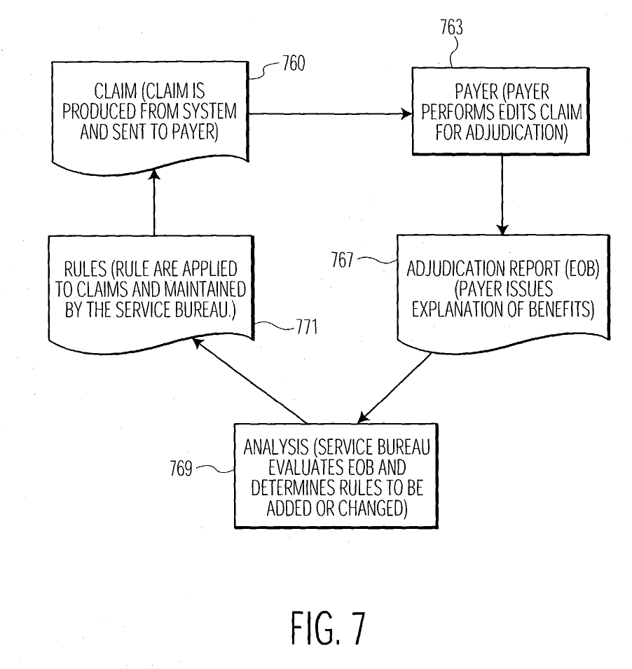

FIG. 7 shows a flowchart of a process employed in deriving and amending rules in response to claim adjudication results from a payer organization. In step 760 collated claim data related to a healthcare claim for a particular patient is submitted by a healthcare provider to a payer organization. The payer organization examines whether the submitted claim complies with payer predetermined requirements and rules associated with the particular patient health plan in step 763. The payer issues to the patient and healthcare provider an explanation of benefits statement following adjudication of the submitted claim using the payer rules in step 767. In step 769, a service (e.g., service 80 of FIG. 1) evaluates the received explanation of benefits, and uses this explanation in monitoring claim rejection issues and rates of adjudication success and failure and in providing information for use in adjusting existing rules in repository 74 or in creating new rules to resolve identified issues. In step 771, new or updated rules are maintained in repository 74 and applied to claim data prior to submission of the claim data to a payer organization to improve claim processing efficiency and to reduce rejection and denial rates.

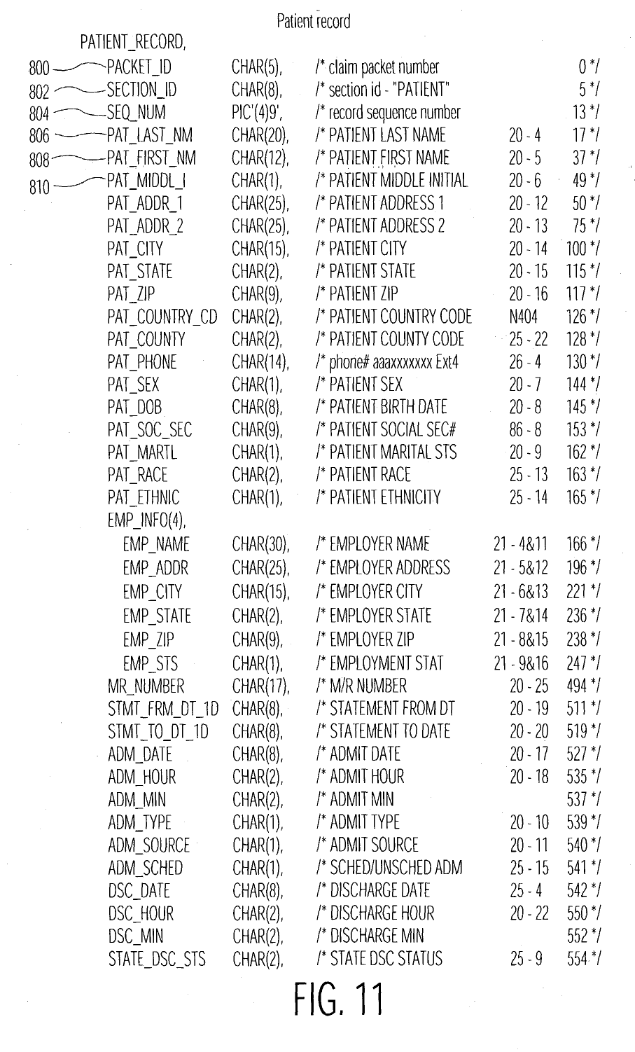

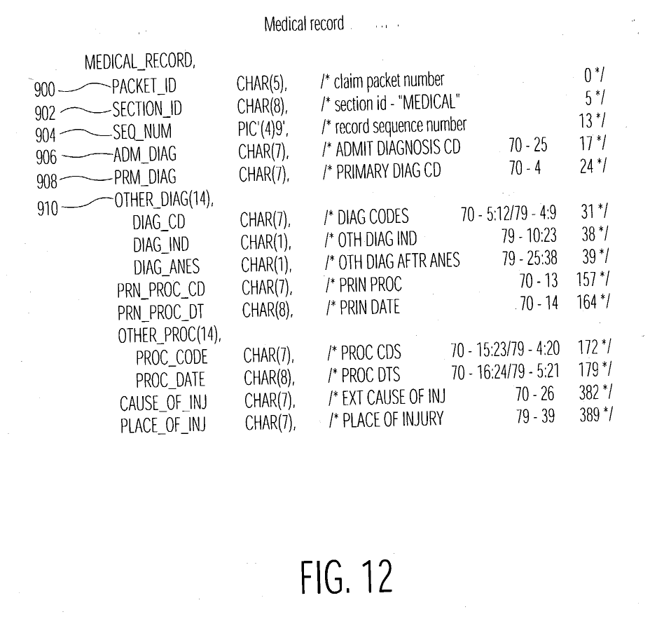

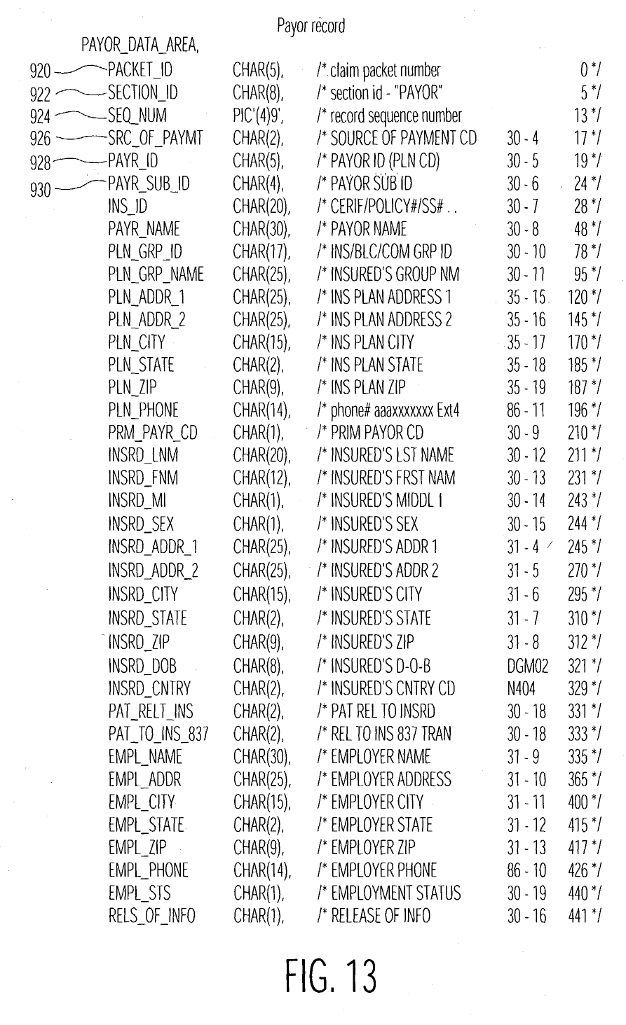

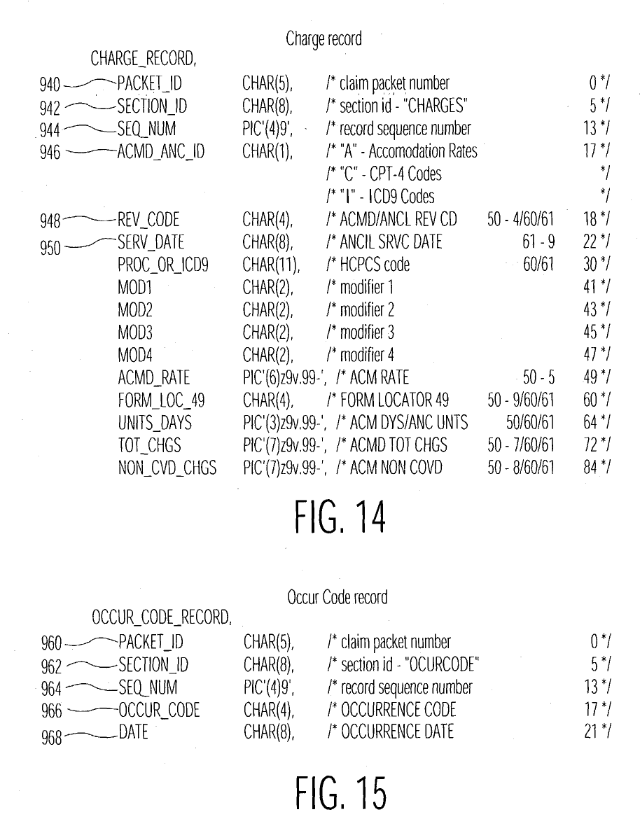

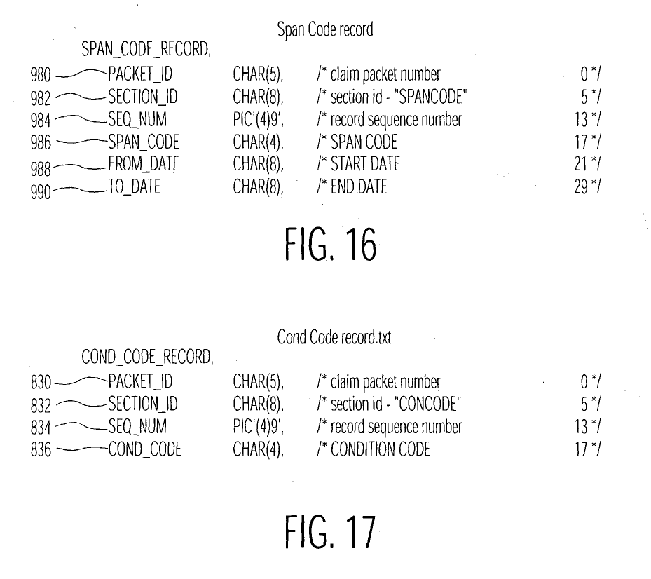

Claim data used for trial adjudication and ultimately submitted to a payer upon amendment (if required) and validation is derived from data repository 68. FIGS. 11-17 show an exemplary data record structure for data elements incorporated in central data repository 68 and used in claim processing. Specifically, FIG. 11 shows a partial patient record data structure, FIG. 12 shows a medical record data structure and FIG. 13 shows a partial payer record data structure. A charge record data structure and occurrence code data structure are presented in FIGS. 14 and 15 respectively and FIGS. 16 and 17 indicate a span code (for use in identifying service charges that are to be grouped on a single claim) and a medical condition code data structure respectively. These record structures are exemplary only and repository 68 typically contains other types of records associated with claim data such as, for example, records concerning ambulance services, rehabilitation services, treatments and other services and activities. The record structures of FIGS. 11-17 are individually accessible in repository 68 using a claim packet identifier (800, 900, 920, 940, 960, 980, 830), section identifier (802, 902, 922, 942, 962, 982, 832) and sequence number (804, 904, 924, 944, 964, 984, 834).

Data in an individual record data structure is field length delimited. In the patient record structure of FIG. 11, for example, a patient last name (806) occupies a fixed length of 20 characters, followed by a patient first name (808) occupying twelve characters and middle initial (810) occupying one character. The record structures of FIGS. 12-17 contain data related to other particular claim data aspects in similar predetermined fixed length fields. The medical record of FIG. 12, for example, contains an admission diagnosis code (906), as well as a primary diagnosis code (908) and other diagnosis codes (910). The payer record of FIG. 13 contains a source of payment code (926), as well as payer identifier (928) and payer sub-identifier (930). The charge record of FIG. 14 contains a service charge code (946), as well as a service charge revision code (948) and service date (950). The occurrence code record of FIG. 15 contains an occurrence identification code (966) and occurrence date (968). The span code record of FIG. 16 contains a span identification code (986), as well as a span determination start date (988) and end date (990) for use in identifying a period when the condition defined by the Span Code took place. The condition code record of FIG. 17 contains a medical condition identification code (836). The items referred to in connection with FIGS. 11-17 are described for exemplary purposes. However, other record items are shown in the record structures of FIGS. 11-14. These other items are representative of the breadth of data that may be included in the various records in the repository 68 structure, for example. In an alternative embodiment, other non-fixed length data record structure or another data record structure may be employed for repository 68.

The claim data in repository 68 is collated by data acquisition unit 32 via interface 10 from multiple different sources as previously described and stored in repository 68 via data management system 64. A data emitter unit 34 provides claim data to an external entity (e.g., portals and participants 20-30) by extracting required claim data from repository 68 and communicating it via interface 10. Data reacher unit 36 is used by functions of the FIG. 1 system to provide read-only access to claim data stored by a remote entity and to make decisions based on this data. Further, claim data repository 68 is searchable by users 30 via external portals 20-28 using data search criteria created using search pattern design function 38. Thereby a user may search for statistically significant data patterns and other data patterns in analyzing the claim data in repository 68.

Search design function 38 employs a specialized category of rules stored in rules repository 74. An authorized user is able to use surveillance portal 28 via interface 10 to use the specialized category of search rules to support a search of rules and claim data information. Searchable information sources include rules repository 74, relationship rules repository 18 as well as claim data repository 68. For this purpose, search pattern evaluator function 40, employs a sub-set of rules executed by rule execution unit 46 to process a definition of a pattern search created by pattern design function 38. Specifically, pattern evaluator function 40 identifies patterns in the data searched according to action steps included in the search definition and reports results to the search initiator via interface 10. A pattern search is executable in response to occurrence of an event. An event may include, for example, a command (in response to a request by a participant), or upon detection of a change in particular data (receipt of a specific diagnosis, for example) or an event may be internally generated such as in response to expiration of a particular time period.

Interface 10 provides access by various interested participants 30 in the claim data processing operation via portals 20-28 for searching, viewing or initiating actions. Thereby a participant (such as a healthcare provider, payer institution representative, patient, employer or government agency) is able to access claim data, payer rules and initiate various actions such as a data correction action, for example. Specifically healthcare providers and healthcare payer representatives are able to access the system via portals 20 and 22 that provide the functions these entities respectively require. A healthcare provider, for example, is able to input financial data and associated clinical data into repository 68 and to initiate and manage claim trial adjudication and other rule-driven processes via portal 20. Similarly, a provider is able to automatically modify its own data based on automated rules or through manual amendment and update. A provider is further able to initiate submission of validated error-free claims for payment and to initiate claim status inquiries. In addition, a provider via portal 20 is able to acquire remittance advice (i.e., information about payments made) and to automatically post acquired advice to corresponding correct accounts as well as to generate and submit secondary and tertiary claims and obtain worklists (of tasks to be performed) and reports in support of management of its business.

A payer institution is able to use portal 22 to store and maintain adjudication rules in repository 74 and to receive claim data for trial or actual (determinative) adjudication as well as to respond to claim status inquiries. A payer is further able to communicate a request for information or remittance advice and obtain worklists and reports and manage its business and revenue cycle. A consumer, such as an individual patient, covered dependent or healthcare plan subscriber with appropriate authorization is able to use consumer portal 24 to view his own claim data records and claim status and research rules governing payment. A consumer is also able to correct errors in his own demographic data or medical record and to schedule appointments via the system. A consumer is also able to obtain account balance, recent transaction records, future deposit information and request payment from a medical expense reimbursement account for items paid out of pocket.

An employer, or another plan administrator, is able to use portal 26 to manage healthcare encounter cycle business and to negotiate healthcare contracts on behalf of a group of persons (employees) and to monitor activity related to those employees. For this purpose, an employer is able to obtain, for example, a worklist or a report identifying incidence of various diagnoses, utilization of various providers, a breakdown of charges (e.g. those paid by members, contractually reduced, or denied). Thereby an employer is able to determine if plan members would benefit from an alternative health plan selection. Surveillance portal 28 enables authorized participants 30 (e.g. a regulator or researcher) to create and implement research projects to analyze stored claim data by searching for patterns or trends in the claim data of repository 68 in conjunction with rules repository 74. Specifically, surveillance portal 28 in conjunction with search pattern design and implementation units 38 and 40 respectively, supports searches to, (1) generate periodic statistical reports, (2) detect claim fraud and abuse, and (3) detect outbreaks of epidemics, caused either by natural disease or by human (terrorist) activity and other searches, for example. Search results may include worklists or reports and search criteria may be stored as rules in rules repository 74.

Interface 10 provides access by participants 30 to claim data and rule repositories 68 and 74 via portals 20-28 using a security function 12, translator function 14 and transport function 16. Security function 12 determines whether a participant is authorized to communicate with another particular participant and whether a participant is authorized to access particular data and assigns participant privileges and entitlements and maintains security and access rules. Unit 12 rejects and tracks unauthorized requests that violate security and other (e.g., HIPAA) policies. Translator function 14 converts data between the different data formats used by internal and external participants in the FIG. 1 system. For this purpose, translator 14 converts data from a first data format into an internally defined intermediate data format and from the intermediate format into a desired output data format. Transport function 16 supports communication of data and messages between internal functions of the FIG. 1 system and between internal functions and external participants. For this purpose function 16 uses relationship rules repository 18 to identify required connection protocols and methods as well as source and destination addresses. Function 16 also uses rules repository 18 in encoding data in the appropriate message format and protocol and in initiating necessary hand shaking and other routines required to implement bidirectional communication.

Relationship rules repository 18 contains information identifying the application programmer interfaces (APIs) used by participant and system software applications and the required procedure for requesting information from particular sources and providing information to particular participants. The participant API identification and related communication information is provided by individual participants for storage in repository 18. The participants retain control over and maintain their respective communication support information. Interface 10 uses the stored predetermined API and communication information in supporting conversion of data from a first data format into an internally defined intermediate data format and from the intermediate format into a desired output data format. As a consequence, participants are able to update their own systems and to communicate with other participants regardless of the rule standards in use or whether the repositories are migrated to new platforms or radically altered in other ways. Also data format standards involved may be changed by an individual participant without impeding operation by other participants. For this purpose interface 10 uses relationship repository 18 to process the validated claim data to provide the data format, protocol, handshaking routine and submission procedure predetermined (and retained and identified in repository 18) by the payer.

The systems, processes and user interface display formats presented in FIGS. 1-17 are not exclusive. Other systems, processes and user interface forms may be derived in accordance with the principles of the invention to accomplish the same objectives. The inventive principles are applicable to streamlining and automating a revenue management process in any industry or field. The principles are particularly applicable to the insurance, government and healthcare industries.

What is claimed is:

1. A system for managing rules used for processing claim data related to provision of healthcare to a patient, comprising:
an interface processor for acquiring data representing rules from a plurality of different sources;
a rules repository for accumulating data representing acquired rules;
a rules processor for initiating application of a selected rule derived from said repository to process claim data in response to a received message; and
a result processor for processing a result for output, said result being derived by said application of said selected rule to said claim data.

2. A system according to claim 1, wherein
a rule comprises a procedure for determining claim elements comply with predetermined requirements including at least one of, (a) health plan reimbursement conditions, (b) health plan format requirements, (c) a reimbursement formula, (d) reimbursement constraints and (e) reimbursement computation procedure.

3. A system according to claim 2, wherein
said claim elements comprise at least one of, (i) a portion of a claim, (ii) a complete claim, (iii) individual records of a claim and (iv) record data associated with an individual patient encounter with a healthcare service provider.

4. A system according to claim 1, wherein
said interface processor derives a rule based on outcomes of previous adjudication of other sets of claim data.

5. A system according to claim 1, wherein
said interface processor derives a rule based on at least one of, (a) documentation and (b) other information provided by healthcare payer institutions.

6. A system according to claim 1, wherein
said rules repository associates a time period of validity with an individual rule, and
said rules processor examines said rule validity period and does not apply a rule at a time and date falling outside of said rule validity period.

7. A system according to claim 1, wherein
a rule contains at least one test used to identify a true or false condition and said rules processor initiates a first action in response to a true condition and a second action in response to a false condition.

8. A system according to claim 7, wherein
said rule contains a combination of tests with individual test results being logically combined to provide an overall true or false result.

9. A system according to claim 7, wherein
said rules repository associates a time period of validity with an individual test, and
said rules processor examines said test validity period and does not apply a test at a time and date falling outside of said test validity period.

10. A system according to claim 1, wherein
said selected rule includes a test for assigning a status of True or False as said result in response to said application of said selected rule to process said claim data.

11. A system according to claim 1, wherein
said interface processor transforms acquired rules to a syntax suitable for storage in said rules repository.

12. A system according to claim 11, wherein
said interface processor parses data representing acquired rules in converting said acquired rules to a common syntax using at least one of, (a) predetermined identifiers and (b) predetermined value sets and suitable for storage in said rules repository.

13. A system according to claim 1, wherein
said rules processor validates at least one of, (a) acquired rules and (b) rules in said repository to verify rules are at least one of, (i) internally consistent, (ii) formatted in a desired syntax and (iii) are not inconsistent with other rules in said repository.

14. A system according to claim 1, wherein
said interface processor manages update of said rules repository and maintains a record of at least one of, (a) a first date of validity of a rule, (b) a last date of validity of a rule and (c) a date identifying when a rule is changed.

15. A system according to claim 1, wherein
said rules repository associates a particular rule with an event and
said rules processor initiates application of said particular rule to process claim data in response to occurrence of said event identified in said received message.

16. A system according to claim 15, wherein
said event includes at least one of, (a) generation of a record for incorporation in claim data for a patient, (b) detection of a record addition to claim data for a patient, (c) detection of a record addition to a patient billing record, (d) detection of a change in a patient billing record and (e) detection of a change in claim data for a patient.

17. A system according to claim 1, wherein
said plurality of different sources include a remotely located rules source provided by a payer and
said rules processor submits said claim data for processing with said payer rules using a claim submission procedure provided by said payer.

18. A system according to claim 1, wherein
said interface processor intermittently interrogates at least one of said plurality of different sources to acquire at least one of, (a) a new rule and (b) an update of an existing rule held in said rule repository.

19. A system according to claim 1, including
said plurality of different sources include rules provided by, (a) a payer, (b) payer messages, (c) payer websites, (d) a rule creation processor for creating rules in response to previously identified claim data deficiencies and (e) regulatory guidelines.

20. A system according to claim 1, wherein
said result processor performs at least one of, (a) schedules a task to be performed by a healthcare worker, (b) creates an error report, (c) creates a record of a result of applying said rules for use in editing claim data, (d) creates an accounting report, (e) generates a claim, (f) receives a remittance, (g) initiates scheduling of review of claim data to be performed by a healthcare worker, (h) initiates generation of an alert message to a user to indicate a deficiency in claim data likely to result in claim denial.

21. A system according to claim 1, including
a communication interface supporting access to said rules repository by at least one of, (a) a patient, (b) a payer, (c) a healthcare provider, (d) an employer of a patient and (e) a governmental agency.

22. A system for managing rules used for processing claim data related to provision of healthcare to a patient, comprising:
an interface processor for acquiring data representing rules from a plurality of different sources;
a rules repository for accumulating data representing acquired rules and for associating an individual acquired rule with an event;
a rules processor for transforming data representing acquired rules to a syntax suitable for storage in said rules repository and in response to occurrence of said event identified in a received message, initiating application of said rule associated with said event to process claim data; and
a result processor for processing a result derived by said application of said selected rule for output.

23. A system according to claim 22, wherein
said interface processor derives a rule based on outcomes of previous adjudication of other sets of claim data.

24. A system according to claim 22, wherein
said interface processor derives a rule based on at least one of, (a) documentation and (b) other information provided by healthcare payer institutions.

25. A method for providing a user interface supporting use of rules in processing claim data related to provision of healthcare to a patient, comprising the steps of:
initiating generation of at least one displayed image including,
a window including at least one display element identifying a test to be performed on claim data as part of a created rule;
a window including at least one display element identifying a claim data item to be processed by said created rule; and
a window including at least one display element identifying a resultant action to be performed in response to application of said created rule to claim data.

26. A method according to claim 25, including the step of
initiating generation of at least one displayed image including,
a window including a display element for identifying a test to be performed on claim data is to validate a claim data item complies with predetermined criteria.

27. A method according to claim 25, including the step of
initiating generation of at least one displayed image including displaying a created rule.

28. A method for providing a user interface supporting creation of a rule for use in processing claim data related to provision of healthcare to a patient, comprising the steps of:
initiating generation of at least one displayed image including,
a window including at least one prompt element permitting user selection of a test to be performed on claim data as part of a created rule, said test being selectable from a plurality of available predetermined tests;
a window including at least one prompt element permitting user identification of a source of claim data to be processed by said created rule;
a window including a user selectable image element for initiating validation of said created rule to verify said created rule complies with predetermined criteria; and
a window including at least one prompt element permitting user selection of a resultant action to be performed in response to application of said created rule to claim data.

29. A method according to claim 28, including the step of
initiating generation of text hints to a user in response to user selection of a prompt element to guide a user in creating said rule.

30. A method according to claim 28, including the step of
forming a created rule to employ a common syntax suitable for storage in a rules repository.

31. A method for managing rules used for processing claim data related to provision of healthcare to a patient, comprising the steps of:
receiving a message;
acquiring data representing rules from a plurality of different sources;
accumulating data representing acquired rules in a rule repository;
initiating application of a selected rule derived from said repository to process claim data in response to said received message; and
processing a result for output, said result being derived by said application of said selected rule to said claim data.

32. A method for managing rules used for processing claim data related to provision of healthcare to a patient, comprising the steps of:
acquiring data representing rules from a plurality of different sources;
associating an individual acquired rule with an event;
transforming data representing acquired rules to a syntax suitable for storage in said rules repository;
accumulating data representing acquired rules in a repository;
receiving a message identifying occurrence of said event;
initiating application of said rule associated with said event to process claim data in response to receiving said message identifying occurrence of said event; and
processing a result for output said result being derived by said application of said selected rule to said claim data.
